(19) United States
(12) Patent Application Publication
(10) Pub. No.: US 2026/0225732 A1
(43) Pub. Date: Aug. 6, 2026

(54) FORMING TABLE

(71) Applicant: Tusas- Turk Havacilik Ve Uzay Sanayii Anonim Sirketi, Kahramankazan, Ankara (TR)

(72) Inventors: Cagri AKIN, Kahramankazan, Ankara (TR); Turker DOLEK, Kahramankazan, Ankara (TR)

(73) Assignee: Tusas- Turk Havacilik Ve Uzay Sanayii Anonim Sirketi, Kahramankazan, Ankara (TR)

(21) Appl. No.: 19/149,891

(22) PCT Filed: Jan. 19, 2024
(86) PCT No.: PCT/TR2024/050041

§ 371 Date: Jul. 22, 2025

(30) Foreign Application Priority Data
Jan. 23, 2023 (TR) 2023/000762

(51) Int. Cl. B64F 5/10

(52) U.S. Cl. CPC B64F 5/10

(57) ABSTRACT

The present invention relates to a body (2); a material (3) that is located on the body (2) for forming; a mandrel (4) that is located on the body (2), which gives form to the material (3); a frame (5) that holds the material (3) on the mandrel (4).

Lighter, transparent polymer materials are generally used for canopies of aircraft, instead of glass. Materials, such as acrylic and polycarbonate, used in the manufacture of aircraft canopy glass are generally formed by vacuum molding methods. However, since the material thickness changes uncontrollably during the vacuum forming process, light refraction levels occurring in the polymer material are not acceptable in today's aircraft (especially fighter aircraft). To prevent this, various forming methods are used to keep the thickness constant.

EP0882566, which is included in the known-state of the art, discloses an adjustable clamping frame for a forming station of a thermoforming machine, wherein heated plates made of thermoplastic are deformed through a mold by means of differential pressure according to its type. At the top of the invention, there is a closed box in which a fixed compression frame that compresses the plate is placed along with a height-adjustable upper frame, so that molded parts of different sizes can be placed and continuously adjusted in the forming station.

U.S. Pat. No. 5,026,514, which is included in the known-state of the art, discloses a conveying system for heating and subsequent shaping of the layer to be formed. The layer to be formed can be moved after installation between the relevant rails or transfer rails.

Thanks to a forming table according to the present invention, canopies on air vehicles can be produced efficiently with minimum change in thickness during a forming process.

Another object of the present invention is to apply a force to the material only for the forming process, without stretching, so that the thickness of the canopy can be controlled depending on the requirements.

A further object of the present invention is to provide low-cost canopy forming by using a single machine in the production of canopies of different sizes and shapes.

The forming table realized to achieve the object of the invention, which is defined in the first claim and other claims dependent thereon, comprises a body; a material positioned on the body for forming; a mandrel that forms the material; a frame that holds the material on the body together with the mandrel.

The forming table according to the invention comprises at least two arms which are placed on the body, opposite each other, to hold the material and mandrel therebetween, wherein the arms constitute the frame, with the capability of rotating around the axis to which they are connected; at least one holder located between opposite arms, which contacts the material throughout at least one side longitudinally so as to ensure the continuation of the shape of the material; at least one channel in the form of an opening throughout the arms, in which the holder is slid by the user, so that a position thereof on the arms can be adjusted according to the size of the material; a part obtained by heating and shaping the material.

In an embodiment of the invention, the forming table comprises the part made of a transparent acrylic thermoplastic material, which is converted from a crystalline atomic structure to an irregular atomic (amorphous) structure as a result of heating, wherein after the part is heated and formed on the body, a temperature of the material is reduced below the glass transition temperature, so that the part is provided with its final, solid form.

In an embodiment of the invention, the forming table comprises the part, which is transparent to transmit light and produced to be used as a canopy for an air vehicle.

In an embodiment of the invention, the forming table comprises at least one joint that enables the arms to turn around the axis to which they are met on the body; the arms that are turned around the joint, at least one clockwise and the other counterclockwise simultaneously, so that the material is bent and stretched.

In an embodiment of the invention, the forming table comprises at least one rod attached to the body, which is fixed by almost taking its shape as a result of contact with the holder that provides the edge form of the material; the holder made of flexible spring steel to take the shape of the rod, which has a curved structure to suit the shape of the canopy.

In an embodiment of the invention, the forming table comprises an apparatus that is placed on opposite arms, in contact with the holder so as to pass through the channel, wherein the apparatus enables the user to adjust the position of the holder by sliding it the through the channel, and can be positioned independently of each other, thus forming the material by stretching it to suit different lateral dimensions.

In an embodiment of the invention, the forming table comprises at least one locking mechanism that prevents a linear movement of the apparatus on the channel, such that the apparatus remains fixed on the arms, wherein the locking mechanism enables stretching of the material when the arms are bent.

In an embodiment of the invention, the forming table comprises a plurality of holes positioned opposite each other, one on the material and the other on the holder, at an interval determined by the manufacturer, along and consecutively in the part where the holder grips the material; a plurality of bolts that are inserted through the holes to assemble the holder and the material together.

In an embodiment of the invention, the forming table comprises at least one pulley fixed on the body and capable of changing the direction of the applied force by rotating on its own axis; an area connected to the arms; at least one elastic element that surrounds the pulley and enables the arms to be moved thanks to the pulley when a force is applied at one end; a trigger in the form of a weight; the pulley that enables the arms to rotate around the joint when the trigger is connected to the elastic element.

In an embodiment of the invention, the forming table comprises the body which enables the material to be kept at a user-predetermined temperature during the forming period in which the material is heated in an oven as a heat source and the part is provided with its final shape.

The forming table realized to achieve the object of the present invention is illustrated in the attached drawings, in which:

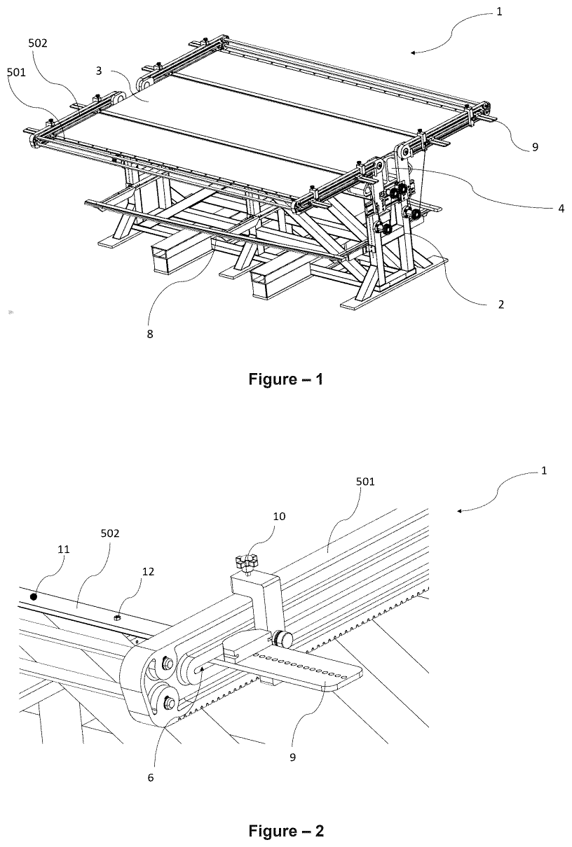

FIG. 1 is a perspective view of the forming table.

FIG. 2 is a perspective view of the forming table.

FIG. 3 is a perspective view of the forming table.

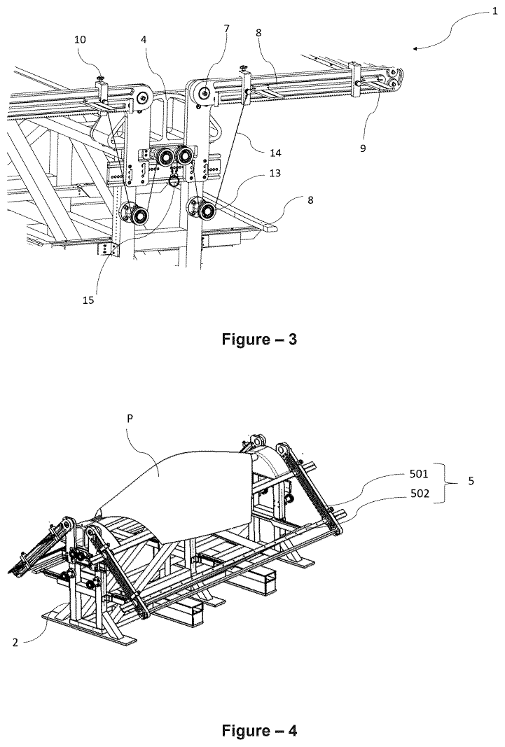

FIG. 4 is a perspective view of the body, part, arms, holder and frame.

All the parts illustrated in figures are individually assigned a reference numeral and the corresponding terms of these numbers are listed below:
1. Forming Table
2. Body
3. Material
4. Mandrel
5. Frame
   501. Arm
   502. Holder
6. Channel
7. Joint
8. Rod
9. Apparatus
10. Locking Mechanism
11. Hole
12. Bolt
13. Pulley
14. Elastic Element
15. Trigger
P. Part

The forming table (1) comprises a body (2); a material (3) that is located on the body (2) for forming; a mandrel (4) that is located on the body (2), which gives form to the material (3); a frame (5) that holds the material (3) on the mandrel (4).

The forming table (1) according to the invention comprises at least two arms (501) that are located opposite each other, constitute the frame (5), and capable of rotating around an axis where they are connected on the body (2), wherein the material (3) and the mandrel (4) are contained between the arms (501), and the arms (501) form the material (3) on the mandrel (4); at least one holder (502) which holds the material (3) on at least one edge thereof longitudinally, so as to provide continuity of the form of the material (3), wherein the holder (502) constitutes the frame (5) and extends between the opposing arms (501); at least one channel (6) that is located on the arms (501) to create an opening longitudinally, wherein the holder (502) is slid in the channel (6), so that its position between the arms (501) can be adjusted by the user according to the size of the material (3); a part (P) produced by subjecting the material (3) to a heat treatment.

The material (3) and the mandrel (4) to form the material are positioned on the body (2), which is used to form the canopies on air vehicles. A frame (5) located on the body (2) holds the material (3) and enables it to be positioned on the body (2).

There is material (3) and mandrel (4) between at least two arms (501) located opposite each other within the frame (5). The arms (501) can rotate around the axis to which they are connected on the body (2). At least one holder (502) extending between opposing arms (501) constituting the frame (5) grips the material (3) longitudinally on at least one edge. In this way, the continuity of the form of the material (3) is ensured by the holder (502). It comprises at least one channel (6) creating a longitudinal opening on the arms (501), wherein the holder (502) is slid in the channel (6), so that its position between the arms (501) can be adjusted by the user according to the size of the material (3). Therefore, a part (P) constituting the canopy is obtained as a result of the thermoforming of the material (3) (FIG. 1).

In an embodiment of the invention, the forming table (1) comprises the part (P) that is made of thermoplastic material (3) changing from a regular structure to a glassy structure due to heat, such that the part (P) is solidified when the material (3) is cooled. The material (3) is made of acrylic thermoplastic material, whose structure changes from a regular structure to a glassy structure due to heat. In this way, the material (3) can be shaped easily. As the temperature of the material (3) heated on the body (2) is reduced below the glass transition temperature, it solidifies and constitutes the part (P). Thus, the part (P) constituting the canopy can be formed (FIG. 2).

In an embodiment of the invention, the forming table (1) comprises the part (P), which is transparent to be used as a canopy on the air vehicle. A lighter canopy is obtained thanks to the part (P) made of transparent thermoplastic material (3).

In an embodiment of the invention, the forming table (1) comprises a joint (7) that enables the arms (501) to rotate around the axis where they are connected to the body (2); the arms (501) rotating around the joint (7) in different directions with each other, so that the material (3) is stretched and bent. The joint (7) enables the arms (501) both to be connected to the body (2) and to rotate around the axis where they are connected to the body (2), one clockwise and the other counterclockwise. In this way, the arms (501) can be bent and the material (3) can almost take the form of the mandrel (4).

In an embodiment of the invention, the forming table (1) comprises at least one rod (8) on the body (2), which allows the holder (502) shaping the edges of the material (3) to be fixed by almost taking the shape of the rod; the holder (502) made of a flexible material such as spring steel, so that the arms (501) take the curved shape of the rod (8) with which they contact, when they rotate around the joint (7). The canopy can be shaped thanks to the flexible holder (502) that can adapt to the form of the rod (8), which has a structure suitable for the curved form of the canopy.

In an embodiment of the invention, the forming table (1) comprises a plurality of apparatuses (9) located on opposing arms (501) to move independently of each other, and enabling the holder (502) to slide within the channel (6) by the user, wherein the apparatuses (9) are located on the holder (502) to pass through the channel (6), thus enabling the material (3) to be formed by stretching after its position on the channel is adjusted according to different lateral dimensions of the material (3) according to its length. The apparatus (9) located on the body (2) to be in contact with the holder (502) is slid along the channel (6) located on the arms (501), and the location of the holder (502) can be adjusted with a precise tolerance on the arms (501). Therefore, canopy production of any size or shape is possible on a single body (2).

In an embodiment of the invention, the forming table (1) comprises a plurality of locking mechanisms (10) that limit the linear movement of the apparatus (9) along the channel (6), thus enabling the material (3) to be fixed in a position desired by the user by bending and stretching the arms (501). The locking mechanism (10) fixes the position of the apparatus (9) on the arms (501). In this way, thickness and tension of the material (3) remains at an amount desired by the user (FIG. 2).

In an embodiment of the invention, the forming table (1) comprises a plurality of holes (11) located opposite each other, one on the material (3) and the other on the holder (502), at an interval determined by the manufacturer, along and consecutively on a part where the material (3) is in contact with the holder (502); a plurality of bolts (12) that are inserted through the holes (11), so that that the holder (502) and the material (3) are fixed to each other. Therefore, effective tensioning is achieved by mounting the holder (502) firmly to the material (3).

In an embodiment of the invention, the forming table (1) comprises at least one pulley (13) fixed on the body (2) and changing a direction of a force by rotating around its own axis; at least one elastic element (14) which is located around the pulley (13), with one end on the arms (501) and the other end subjected to the force, and which enables the force applied to its end to be transferred to the arms (501) via the pulley (13); a trigger (15) connected by the user to the elastic element (14) and triggering the movement of the arms (501); the pulley (13) that enables the arms (501) to rotate around the joint (7) when the trigger (15) is connected to the elastic element (14). The force to be applied to the arms (501) is applied by means of the fixed pulley (13) system. The arms (501) are bent when the trigger (15) is positioned by the user at the end of the pulley (13) system (FIG. 3).

In an embodiment of the invention, the forming table (1) comprises the body (2) placed in a heat source which is an oven, thus enabling the material (3) to be kept at a temperature determined by the user throughout the forming period. Therefore, temperature of the material (3) is kept constant throughout the forming process in order for the part (P) to take its final form.

1. A forming table (1) comprising a body (2); a material (3) that is located on the body (2) for forming; a mandrel (4) that is located on the body (2), which gives form to the material (3); a frame (5) that holds the material (3) on the mandrel (4), wherein comprising at least two arms (501) that are located opposite each other, constitute the frame (5), and capable of rotating around an axis where they are connected on the body (2), wherein the material (3) and the mandrel (4) are contained between the arms (501), and the arms (501) form the material (3) on the mandrel (4); at least one holder (502) which holds the material (3) on at least one edge thereof longitudinally, so as to provide continuity of the form of the material (3), wherein the holder (502) constitutes the frame (5) and extends between the opposing arms (501); at least one channel (6) in the form of an opening throughout the arms (501), in which the holder (502) is slid by the user, so that a position thereof on the arms (501) can be adjusted according to the size of the material (3), a part (P) produced by subjecting the material (3) to a heat treatment.

2. A forming table (1) according to claim 1, wherein comprising the part (P) that is made of thermoplastic material (3) changing from a regular structure to a glassy structure due to heat, such that the part (P) is solidified when the material (3) is cooled.

3. A forming table (1) according to claim 1, wherein comprising the part (P), which is transparent to be used as a canopy on an air vehicle.

4. A forming table (1) according to claim 1, wherein comprising a joint (7) that enables the arms (501) to rotate around the axis where they are connected to the body (2); the arms (501) rotating around the joint (7) in different directions with each other, so that the material (3) is stretched and bent.

5. A forming table (1) according to claim 4, wherein comprising at least one rod (8) on the body (2), which allows the holder (502) shaping the edges of the material (3) to be fixed by almost taking the shape of the rod; the holder (502) made of a flexible material such as spring steel, so that the arms (501) take the curved shape of the rod (8) with which they contact, when they rotate around the joint (7).

6. A forming table (1) according to claim 1, wherein comprising a plurality of apparatuses (9) located on opposing arms (501) to move independently of each other, and enabling the holder (502) to slide within the channel (6) by the user, wherein the apparatuses (9) are located on the holder (502) to pass through the channel (6), thus enabling the material (3) to be formed by stretching after its position on the channel is adjusted according to different lateral dimensions of the material (3) according to its length.

7. A forming table (1) according to claim 6, wherein comprising a plurality of locking mechanisms (10) that limit the linear movement of the apparatus (9) along the channel (6), thus enabling the material (3) to be fixed in a position desired by the user by bending and stretching the arms (501).

8. A forming table (1) according to claim 1, wherein comprising a plurality of holes (11) located opposite each other, one on the material (3) and the other on the holder (502), at an interval determined by the manufacturer, along and consecutively on a part where the material (3) is in contact with the holder (502); a plurality of bolts (12) that are inserted through the holes (11), so that that the holder (502) and the material (3) are fixed to each other.

9. A forming table (1) according to claim 4, wherein comprising at least one pulley (13) fixed on the body (2) and changing a direction of a force by rotating around its own axis;
at least one elastic element (14) which is located around the pulley (13), with one end on the arms (501) and the other end subjected to the force, and which enables the force applied to its end to be transferred to the arms (501) via the pulley (13); a trigger (15) connected by the user to the elastic element (14) and triggering the movement of the arms (501); the pulley (13) that enables the arms (501) to rotate around the joint (7) when the trigger (15) is connected to the elastic element (14).

10. A forming table (1) according to claim 1, wherein comprising the body (2) placed in a heat source which is an oven, thus enabling the material (3) to be kept at a temperature determined by the user throughout the forming period.
